(19) United States
(12) Patent Application Publication
(10) Pub. No.: US 2005/0138964 A1
(43) Pub. Date: Jun. 30, 2005

(54) Facility for melting dusts

(76) Inventor: Alfred Edlinger, Bartholomaberg (AT)

Correspondence Address: Robert J Schneider;Chapman and Cutler, 111 West Monroe Street, 16th Floor, Chicago, IL, 60603, US

(21) Appl. No.: 10/504,377

(22) PCT Filed: Feb. 14, 2003
(86) PCT No.: PCT/AT03/00047

(30) Foreign Application Priority Data
Feb. 21, 2002 (AT) A 269/2002

(51) Int. Cl. C03B 5/235

(52) U.S. Cl. 65/28; 431/173; 75/453

(57) ABSTRACT

In a device for melting precrushed material and/or dusts such as, e.g., furnace dusts or steel dusts, marl and lime dust mixtures, shredder light fractions and/or crushed waste substances, in which the material and/or dusts are injected into a combustion chamber along with a carrier gas, the dusts and/or are introduced axially, and the carrier gas is introduced tangentially, into a cyclone 3. The cyclone 3 is connected with a combustion chamber (8) via a substantially axially directed discharge opening (9).

The invention relates to a device for melting precrushed material and/or dusts such as, e.g., furnace dusts or steel dusts, marl and lime dust mixtures, shredder light fractions, broken glass, quartz sand, alkaline and alkaline earth salts, waste incineration dusts and/or crushed waste substances, in which the precrushed material and/or dusts are injected into a combustion chamber along with a carrier gas.

To melt fine solids as well as optionally slurries, it is known to use burners that can be operated with different fuels. The solids in that case will be injected into the combustion chamber or a melting cyclone by employing more or less expensive injectors. Such injectors or systems by which solids are injected into a combustion chamber using carrier gases usually require complex nozzles which, as a rule, even have to be controllable with a view to adjusting suitable premixtures. Known injectors are highly prone to wear, wherein varying blending rates are moreover observed with known injectors at an increasing abrasion or wear, particularly when using extremely abrasive charging materials, thus leading to irregular melting results. In addition, injectors are, as a rule, operated in a pulsed mode, which may again cause irregularities in the melting behavior.

The invention aims to provide a device of the initially defined kind, which is characterized by an extremely low wear even when using extremely abrasive raw materials, and by which coarse charging material too can be melted without any difficulties. Furthermore, the invention aims to ensure material or dust injection free of pulsations as well as high melt throughputs using extremely small-structured units. Finally, the configuration according to the invention aims to minimize refractory problems related to the lining of the combustion chamber and to do with simple devices in which the melting procedure can to a great extent be conducted without the melts contacting the walls of the combustion chamber.

To solve this object, the device according to the invention essentially consists in that the precrushed material or dusts are introduced axially, and the carrier gas is introduced tangentially, into a cyclone and that the cyclone is connected with a combustion chamber via a substantially axially directed discharge opening. Due to the fact that the combustion chamber proper is preceded by a cyclone which functions as a dosing cyclone as in contrast to the usual mode of operation of a cyclone, it is feasible by the tangential blowing-in of carrier gas to impart to the material a suitable rotational movement, which leads to the injection of the precrushed material and/or dusts and carrier gas into the consecutively arranged combustion chamber under a defined spin. The mode of operation of the dosing cyclone in terms of action can also be compared to an air vessel such that a continuous injection free of pulsations of dusts and/or fine solids into a consecutively arranged combustion chamber will be safeguarded in a simple manner. The combustion chamber itself can be heated by burners to the temperatures required for dust melting, for instance temperatures ranging between 1200° C. and 1650° C., wherein the configuration is advantageously devised such that fuel and optionally a further carrier gas are injected into the combustion chamber in a manner coaxial with the discharge opening of the cyclone. Such a coaxial supply of fuels allows the solids injected under a spin to be mixed with the fuel gases in a first region, whereupon the rapid melting of the fine-particle solids is rendered feasible at a particularly rapid temperature transfer within the flame, whereby the circulating spin flow can be maintained to the major extent. This brings about a relatively long time of contact with the flame over a short axial length, since the solids particles substantially in the burning cone along a helical line cover a relatively long path relative to the axial length.

In order to enhance this spin effect in the region of transition from the dosing cyclone into the combustion chamber, or into the flame region of the burner, the configuration advantageously is devised such that guide bodies or swirl vanes are arranged in the region of the discharge opening of the cyclone. The optionally preheated dusts injected by hot wind will, thus, exert only a slight thermal load on the spin tube or downspout at the transition to the combustion chamber, wherein the thermal load caused by the combustion chamber heat will even be further reduced if the configuration is devised such that the discharge opening is designed as a tube having a cooled jacket. Such a configuration in which fuel is supplied in a manner coaxial with the downspout, or the swirl vanes of the discharge opening, will at the same time result in a cooled burner, so that even the burner nozzles will be protected against premature wear. The cooled jacket in this case can be designed in a water-cooled manner, wherein water-cooled burner nozzles can at the same time be designed as concentric ring nozzles.

In order to maintain the desired flow conditions in the combustion chamber, it may be advantageous to impart a suitable spin and, in particular, a counter spin also to the introduced fuel and/or further carrier gas or combustion gases fed to the burner nozzles. A particularly good controllability of the flow conditions in this respect will be provided if, as in accordance with a preferred further development, the configuration is devised such that the discharge opening of the cyclone is designed as a perforated downspout whose openings provided in the jacket run into a concentric ring channel arranged for the supply of fuels and/or the supply of a further carrier gas Due to the specific design of the perforations or openings provided in the downspout or spin tube, a dynamic equilibrium can be adjusted between the outer and inner gas flows. In the downspout itself low flow speeds will, as a rule, prevail so as to ensure minimum wear by abrasion. In order to increase the turbulences in the combustion zone, it may be reasonable to effect a partial combustion already in the downspout with the fuel gases flowing into the downspout via said perforations. Due to the stoichiometric and thermal volume increase, higher flow speeds and accordingly intensified turbulences will only occur in the exit region of the downspout, thus enabling a particularly high heat-mass transfer. As already mentioned, the spin occurring in the ring channel provided for the supply of fuels or combustion gases can be chosen inversely to the spin occurring in the interior of the downspout or spin tube, in order to ensure particularly intense mingling in the discharge region of the cyclone. The dynamic equilibrium and, in particular, the dynamic gas distribution between the inner tube and the jacket tube can still be substantially enhanced in that, as in correspondence with a preferred configuration, the exit nozzle for the fuel and/or further carrier gas into the combustion chamber is designed as a slotted nozzle. Such an annular slot can be designed in a manner adjustable relative to the downspout within its slot width by simple coaxial displacement of the water-cooled outer tube, thus enabling the respective amount of combustion gas reaching the downspout via the perforations to be controlled by an appropriate back-up in the region of the adjustable slotted nozzles.

Advantageously, the configuration according to the invention is devised such that an oxygen-containing, combustion-promoting gas and, in particular, hot blast is used as a carrier gas.

A suitable melt outlet opening is provided on the side located opposite the entry site of the solids, i.e. in other words, on the combustion chamber side located opposite the discharge opening of the cyclone, the configuration preferably being devised such that the combustion chamber comprises a melt outlet opening near or in its bottom. Such a melt outlet opening can be designed as a tap opening including an accordingly simple closure, or allow for the continuous extraction of melt. In the region of the bottom, or of said melt outlet opening, the inner wall may be designed in an accordingly conical manner such that molten slag will deposit in the region of the melt outlet opening while forming a slag deposit. This ensures high protection to the refractory lining, whereby a defined transport direction and defined pressure conditions are altogether provided by the burner and the cyclone so as to enable also raw material to be sucked into the dosing cyclone. If raw material were sucked in from an appropriate bin via a centric tube with a cellular wheel sluice interposed, this would again result in a pulsed introduction of solids, yet the use of the dosing cyclone simultaneously acting as an air vessel causes the pulsations to be evened out to such an extent that uniform flow conditions and hence a defined flight of droplet will be safeguarded.

The combustion exhaust gas formed in the combustion chamber preferably is again discharged in a tangential manner in order to ensure the desired helical flow even in the combustion chamber and to provide an appropriate premixing region and an appropriate melting region over a particularly short axial length. In an advantageous manner, the configuration is therefore devised such that at least one opening for the escape of exhaust gases from the combustion chamber is tangentially connected to the combustion chamber close to the discharge opening of the cyclone, the centrifugal force thus enabling the separation of even the finest droplets from the exhaust gas.

Overall, the dust contained in the carrier gas is finely and uniformly dispersed in the dosing cyclone by the device according to the invention, compression and acceleration taking place in the cyclone along the vertical axis at the same time. Suitable swirl vanes or guide apparatus like spirals can be installed in the spin tube or downspout for the optimum guidance of the two-phase flow. In order to ensure optimum mingling at a particularly low combustion chamber height, optionally adjustable nozzles can be installed in the consecutively provided premixing region, i.e. in the region where the two-phase flow is fed with the fuels or flame. In the main, the combustion chamber may be designed to have structural heights ranging, for instance, between 0.5 and 1.5 m.

Besides precalcined marls forming marl slags, lime marl, steel dusts, contaminated soils, shredder light fractions, crushed household refuse, dried sewage sludge, top gas dusts such as, for instance, blast furnace dusts, Corex or HIsmelt dusts, electroplating sludges, brown-coal fly ashes or mixtures of such dusts may also be envisaged as charging materials for a dust melting device of this type. With the appropriate process control and adequate oxygen feeding, it is also feasible to recover copper from copper pyrite by simultaneously blowing in quartz sand, whereby the SO formed may subsequently be removed from the exhaust gas and optionally processed into sulfuric acid. The pertinent reaction proceeds according to the following equation:

$${CuFeS}_{2} + {SiO}_{2} {\to }^{{O}_{2}} Cu + {FeSiO}_{2} + {So}_{2} ⋀$$

Since no injector is required in the device according to the invention and merely a dosing cyclone is used, even extremely abrasive raw materials can be charged in an advantageous manner without causing too much wear. Unlike with injectors, also coarse-grained material such as, for instance, charging material having a dₘₐₓ of up to 500 μm to extremely fine-grained material having a diameter of <1 μm can, at the same time, be processed by the device according to the invention without any major adaptations being required. The method can be operated as a continuous melting method, minimizing refractory problems by ensuring a practically contact-free melt extraction. The helically guided, rotating exhaust gas too centers the melt in a manner that in the region of the melt outlet opening any contact of melt can only occur in the central zone. The device according to the invention in a simple manner can also be used with electric furnaces to process steel dusts and with iron-bath reduction rectors, wherein the desired basicity and, in particular, a basicity of slags C/S (CaO/SiO₂) ranging between 1.2 and 2.5 can be directly adjusted by choosing the appropriate fluxes. By the addition of marl or sand, a highly active synthetic slag will be obtained from furnace by-pass dust derived from the production of clinker, which stands out for its high basicity C/S (CaO/SiO₂) of around 3 and a high alkali content, the alkalis evaporating at least partially during combustion.

The device according to the invention is also perfectly suited for the preparation of melt in glass production. To this end, a method for producing glass and/or water glass using the initially defined device is proposed, which is characterized in that broken glass and/or quartz sand as well as alkaline and/or alkaline earth salts such as, e.g., soda, potash or alkaline-containing cement furnace dust, are injected into a combustion chamber via a dosing cyclone, whereby combustion exhaust gases and/or gaseous fuels are introduced as jackets of the mineral components and ignited in the combustion chamber. Preferably, broken glass having a diameter of approximately 0.5 mm is used.

In the following, the invention will be explained in more detail by way of a melting unit configuration schematically illustrated in the drawing. Therein,

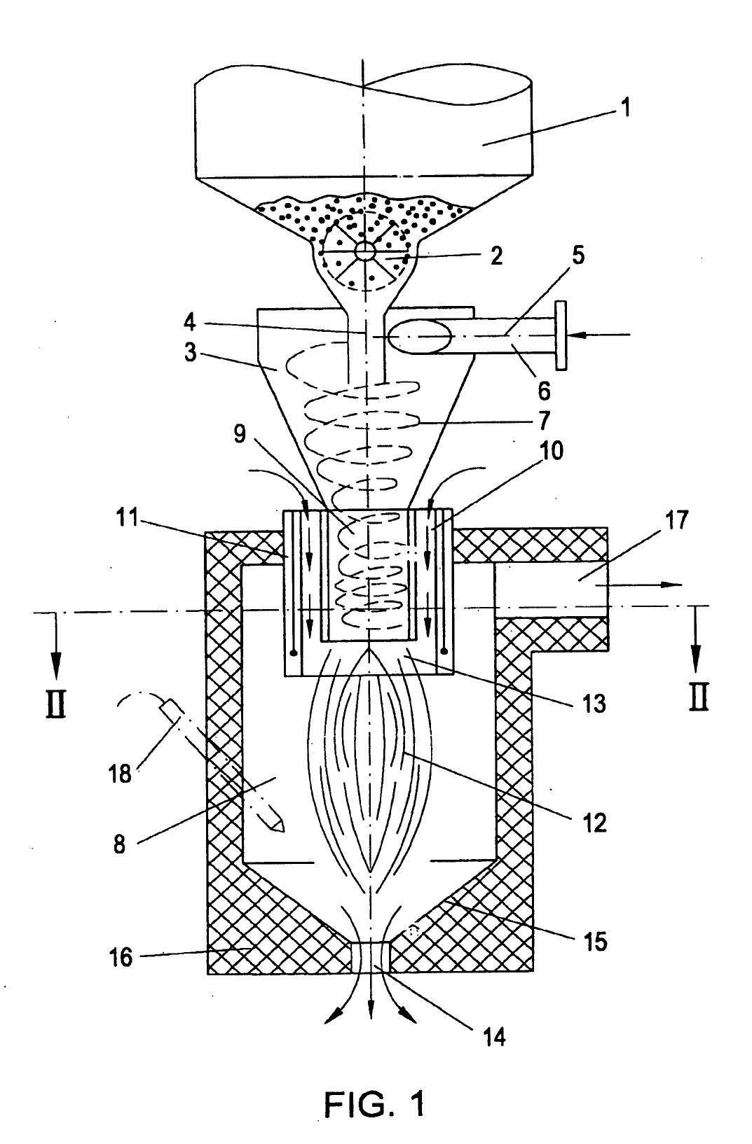

FIG. 1 is a partially sectioned, schematic side view of a melting device according to the invention;

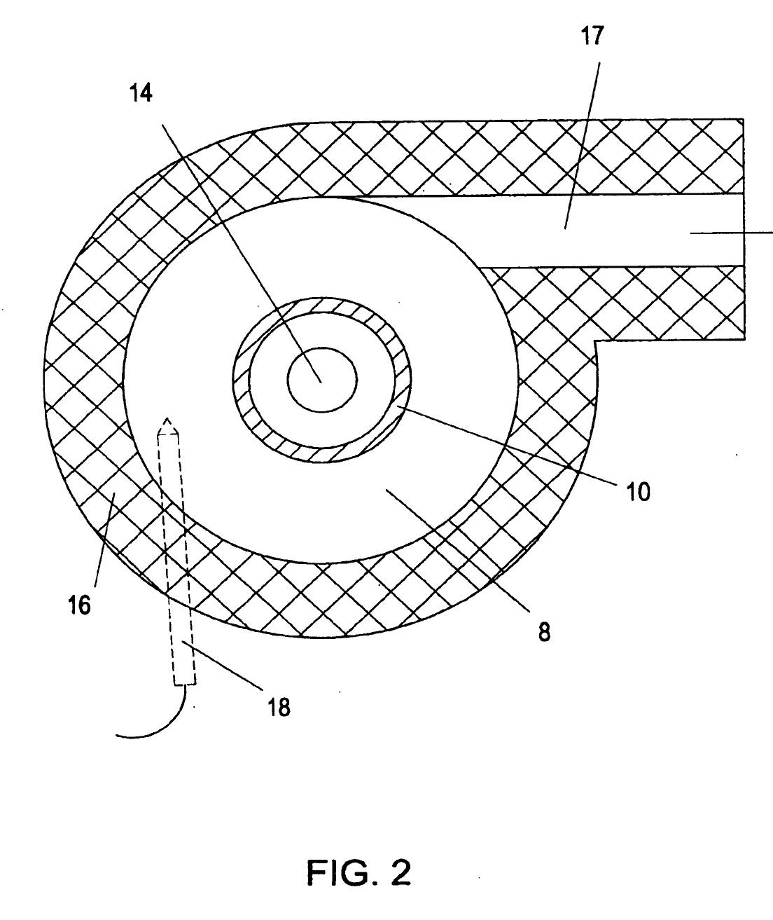

FIG. 2 is a section along line II-II of FIG. 1;

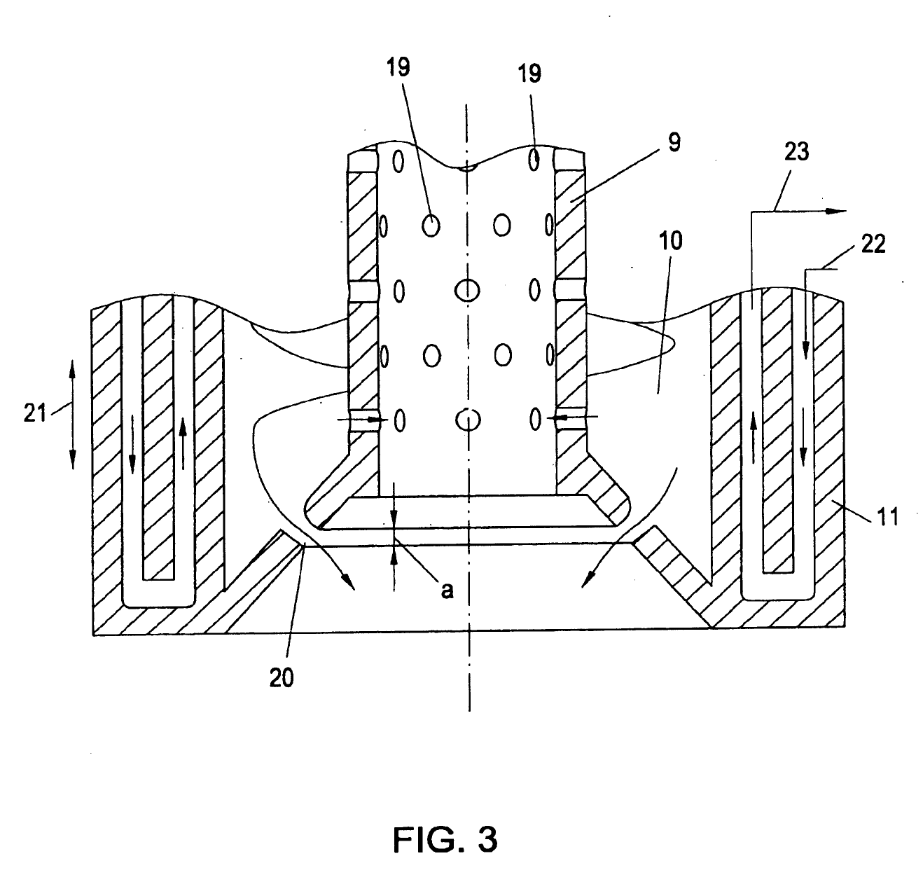

FIG. 3 shows a detail of a modified cyclone discharge opening on an enlarged scale; and

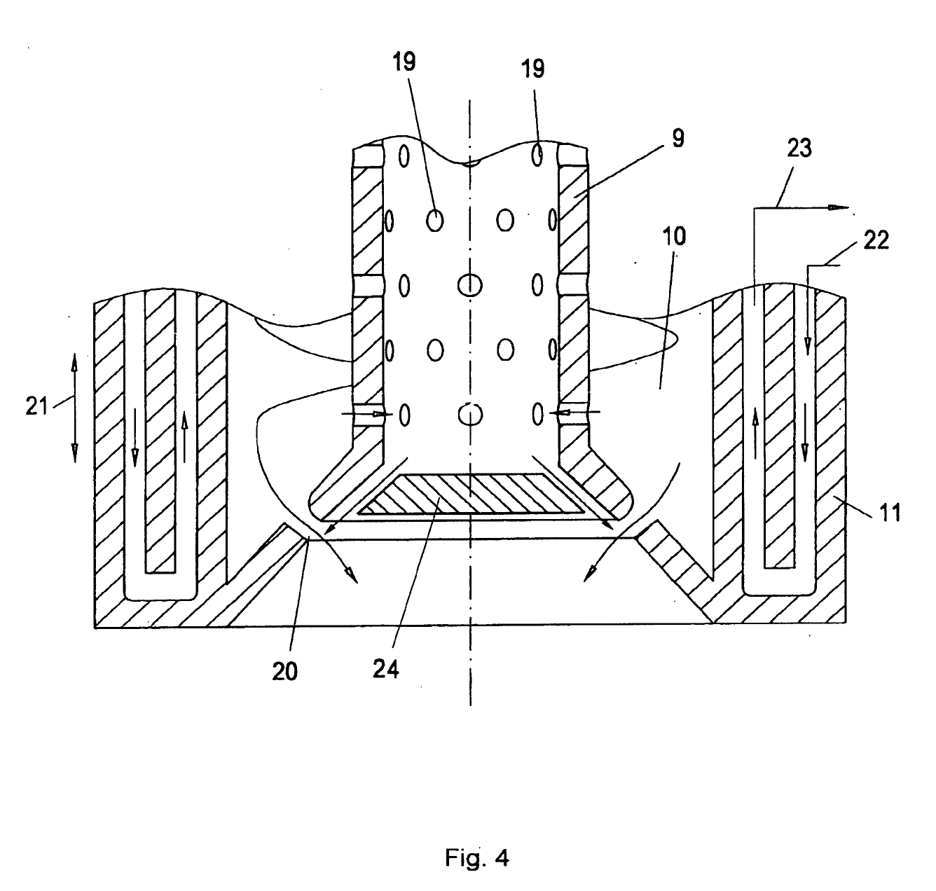

FIG. 4 shows a detail of a further modified cyclone discharge opening configuration.

In FIG. 1, a raw-material hopper is denoted by 1, from which material is sucked into a cyclone 3 via a cellular wheel sluice 2. The suction of the raw material in this case takes place in a substantially axial direction, the axis being denoted by 4.

Oxygen and/or hot air is blown into the cyclone 3 through a connection pipe 6 in a substantially tangential direction, i.e. in a direction 5 intersecting with, or crossing, the axis 4, thus, on the one hand, causing material to be sucked in from the raw material hopper 1 and, on the other hand, causing a helical movement illustrated by broken line 7 to be imparted to the material. The material is accelerated along this helical line 7 and compressed and ejected in the axial direction, i.e. still in the direction of the axis 4, into a consecutively arranged combustion chamber 8. The discharge opening of the cyclone is designed as a tube 9 and may contain swirl vanes or spirals in order to stabilize or maintain the flow course along the helical line. The tube 9 may be designed as a cylindrical tube having a constant cross section or having a cross section diminishing in the discharge direction. Coaxial with this tubular end section, or discharge section, of the cyclone is provided a fuel supply channel 10, through which gaseous, liquid or even solid fuels may be injected. The fuel supply is coaxially surrounded by an outer tube 11, wherein a cooling means may in the main be provided here, and the outer tube 11 may, for instance, be designed as a double-jacket tube including a ring jacket.

An appropriate melting temperature, for instance a temperature ranging between 1200° C. and 1650° C. may be adjusted inside the combustion chamber 8, to which end the fuel supplied via channels 10 is ignited. The pertinent flame is schematically indicated by 12. Immediately at the exit of the helically circulating particles from the transitional tube section 9, mingling of the solids under spin with the fuel takes place in a first premixing zone 13 so as to cause a particularly intense and rapid transfer of the combustion heat to the particles. As a result, the substantially helical flow is maintained substantially over the axial length of the combustion chamber 8, viewed in the direction of the axis 4. The material melted under the formation of melt droplets via bottom opening 14 reaches an accordingly continuing treatment stage such as, for instance, a melt granulator, a sinter cooler or a vapor-operated mill, wherein copper melt can be separated from the slag with copper pyrite being used as charging material, before any further treatment will be performed. The combustion chamber 8 can be lined with refractory material, whereby a slag layer will deposit in the region of the conical walls 15 near the outlet opening, said slag layer suitably protecting the refractory material 16 of the wall of the combustion chamber. A portion of the exhaust gas formed during combustion naturally escapes through opening 14 along with the melt. The major portion of these exhaust gases is, however, again discharged tangentially via an exhaust-gas outlet opening 17 and, after this, can be further used in an appropriate manner. The exhaust gases may be utilized, in particular, for calcining, preheating raw materials or in any other manner, wherein it is also feasible as a function of the charging substances to extract or separate respective substances interfering with the exhaust gases. This applies, in particular, to zinc-containing or SO₂-containing gases, which will be appropriately cleaned prior to any further use.

From the illustration according to FIG. 2 it is apparent that the exhaust gas channel 17 is arranged substantially tangentially relative to the combustion chamber 8 such that it is also feasible to maintain the appropriately circulating flow via exhaust gas suction. Further apparent from the sectional illustration according to FIG. 2 are the central outlet opening 14 as well as the fuel supply channel 10 having an annular cross section.

In the illustrations according to FIG. 1 and FIG. 2, a burner lance 18 by which the flow conditions in the combustion chamber can be further varied is additionally entered in dot-and-dash lines. To this end, the burner may be installed in an accordingly slanted manner and oriented in an accordingly tangential manner.

With raw materials having maximum diameters of >150 μm, it may be required for the formation of stable flow conditions and an accordingly long dwell time in a short-structured chamber to heat the material in a forehearth, since otherwise the dimensions of the combustion chamber would have to be increased.

The illustration according to FIG. 3 depicts on an enlarged scale a detail of a cyclone discharge opening by which the flow conditions inside the combustion chamber can be influenced in a substantially simpler manner. The cyclone exit opening is again designed as a tube 9 comprising perforations or openings 19 in its jacket. These openings 19 run into the ring channel 10 surrounding the jacket of the tube 9 and via which fuel and optionally combustion air can be fed. The fuel reaches the combustion space via a slotted nozzle 20, the width a of the annular slot of the slotted nozzle 20 being variable by an axial displacement of the outer tube 11 in the sense of double arrow 21 relative to the perforated tube 9. With an accordingly reduced slot width a, fuel and combustion air will reach the region of the cyclone discharge opening through the perforations 19 of the inner tube 9 so as to enable pre-ignition and pre-combustion in this region. By installing suitable guide bodies in the discharge tube 9, or outer tube 11, the spins in the two channels can be accordingly adjusted and optionally chosen in opposite directions.

As is clearly apparent from FIG. 3, the outer tube 11 is designed as a double-jacket tube with coolant being feedable via duct 22 and accordingly heated medium being removable via duct 23. In the illustration according to FIG. 4, a nozzle plate or nozzle guide body 24 is arranged on the discharge side to optimize further flow guidance. The cross sectional narrowing in the discharge region leads to a further spin increase and promotes combustion so as to enable a shortening of the respectively required flame length.

Overall, it is to be observed that the downspout 9 can be designed the shorter the higher the fineness of the materials charged.

1. A device for melting precrushed materials or dusts, in which the precrushed materials or dusts are injected into a combustion chamber along with a carrier gas, wherein the precrushed materials or dusts are introduced axially, and the carrier gas is introduced tangentially, into a cyclone (3), and the cyclone (3) is connected with a combustion chamber (8) via a substantially axially directed discharge opening (9).

2. A device according to claim 1, wherein fuel is injected into the combustion chamber (8) in a manner coaxial with the discharge opening (9) of the cyclone (3).

3. A device according to claim 1, wherein guide bodies or swirl vanes are arranged in the region of the discharge opening (9) of the cyclone (3).

4. A device according to claim 1, wherein said carrier gas is an oxygen-containing, combustion promoting gas.

5. A device according to claim 1, wherein the combustion chamber (8) comprises a melt outlet opening (14) near or in a bottom of said combustion chamber (8).

6. A device according to claim 1, wherein at least one opening (17) for escape of exhaust gases from the combustion chamber (8) is tangentially connected to the combustion chamber (8) close to the discharge opening (9) of the cyclone (3).

7. A device according to claim 1, wherein the discharge opening (9) of the cyclone (3) is designed as a perforated downspout comprising openings (19) provided in a jacket of said discharge opening (9), and wherein said openings (19) run into a concentric ring channel arranged for at least one of supply of fuels and supply of a second carrier gas.

8. A device according to claim 1, comprising an exit nozzle for fuel into the combustion chamber (8), designed as a slotted nozzle.

9. A device according to claim 8, wherein slot width of the slotted nozzle is adjustable.

10. A method for producing glass or water glass comprising the steps of:
injecting glass-making materials into a combustion chamber (8) via a dosing cyclone (3), the cyclone (3) being connected with a combustion chamber (8) via a substantially axially directed discharge opening (9); and
introducing carrier gas tangentially into the dosing cyclone;
wherein combustion exhaust gases or gaseous fuels are introduced as jackets of mineral components of the glass-making materials, and are ignited in the combustion chamber (8).

11. A device according to claim 2, wherein a second carrier gas is injected with said fuel into the combustion chamber (8) in a manner coaxial with the discharge opening (9) of the cyclone (3).

12. A device according to claim 2, wherein guide bodies or swirl vanes are arranged in the region of the discharge opening (9) of the cyclone (3).

13. A device according to claim 1, wherein said carrier gas is hot blast.

14. A device according to claim 2, wherein said carrier gas is an oxygen-containing, combustion promoting gas.

15. A device according to claim 3, wherein said carrier gas is an oxygen-containing, combustion promoting gas.

16. A device according to claim 2, wherein the combustion chamber (8) comprises a melt outlet opening (14) near or in a bottom of said combustion chamber (8).

17. A device according to claim 3, wherein the combustion chamber (8) comprises a melt outlet opening (14) near or in a bottom of said combustion chamber (8).

18. A device according to claim 4, wherein the combustion chamber (8) comprises a melt outlet opening (14) near or in a bottom of said combustion chamber (8).

19. A device according to claim 2, wherein at least one opening (17) for escape of exhaust gases from the combustion chamber (8) is tangentially connected to the combustion chamber (8) close to the discharge opening (9) of the cyclone (3).

20. A device according to claim 3, wherein at least one opening (17) for escape of exhaust gases from the combustion chamber (8) is tangentially connected to the combustion chamber (8) close to the discharge opening (9) of the cyclone (3).

21. A device according to claim 4, wherein at least one opening (17) for escape of exhaust gases from the combustion chamber (8) is tangentially connected to the combustion chamber (8) close to the discharge opening (9) of the cyclone (3).

22. A device according to claim 5, wherein at least one opening (17) for escape of exhaust gases from the combustion chamber (8) is tangentially connected to the combustion chamber (8) close to the discharge opening (9) of the cyclone (3).

23. A device according to claim 2, wherein the discharge opening (9) of the cyclone (3) is designed as a perforated downspout comprising openings (19) provided in a jacket of said discharge opening (9), and wherein said openings (19) run into a concentric ring channel arranged for at least one of supply of fuels and supply of a second carrier gas.

24. A device according to claim 3, wherein the discharge opening (9) of the cyclone (3) is designed as a perforated downspout comprising openings (19) provided in a jacket of said discharge opening (9), and wherein said openings (19) run into a concentric ring channel arranged for at least one of supply of fuels and supply of a second carrier gas.

25. A device according to claim 4, wherein the discharge opening (9) of the cyclone (3) is designed as a perforated downspout comprising openings (19) provided in a jacket of said discharge opening (9), and wherein said openings (19) run into a concentric ring channel arranged for at least one of supply of fuels and supply of a second carrier gas.

26. A device according to claim 5, wherein the discharge opening (9) of the cyclone (3) is designed as a perforated downspout comprising openings (19) provided in a jacket of said discharge opening (9), and wherein said openings (19) run into a concentric ring channel arranged for at least one of supply of fuels and supply of a second carrier gas.

27. A device according to claim 6, wherein the discharge opening (9) of the cyclone (3) is designed as a perforated downspout comprising openings (19) provided in a jacket of said discharge opening (9), and wherein said openings (19) run into a concentric ring channel arranged for at least one of supply of fuels and supply of a second carrier gas.

28. A device according to claim 2, comprising an exit nozzle for fuel into the combustion chamber (8), designed as a slotted nozzle.

29. A device according to claim 3, comprising an exit nozzle for fuel into the combustion chamber (8), designed as a slotted nozzle.

30. A device according to claim 4, comprising an exit nozzle for fuel into the combustion chamber (8), designed as a slotted nozzle.

31. A device according to claim 5, comprising an exit nozzle for fuel into the combustion chamber (8), designed as a slotted nozzle.

32. A device according to claim 6, comprising an exit nozzle for fuel into the combustion chamber (8), designed as a slotted nozzle.

33. A device according to claim 7, comprising an exit nozzle for fuel into the combustion chamber (8), designed as a slotted nozzle.

34. A device according to claim 28, wherein slot width of the slotted nozzle is adjustable.

35. A device according to claim 29, wherein slot width of the slotted nozzle is adjustable.

36. A method according to claim 10, wherein fuel is injected into the combustion chamber (8) in a manner coaxial with the discharge opening (9) of the cyclone (3).

37. A method according to claim 36, wherein a second carrier gas is injected with said fuel into the combustion chamber (8) in a manner coaxial with the discharge opening (9) of the cyclone (3).

38. A method according to claim 10, wherein guide bodies or swirl vanes are arranged in the region of the discharge opening (9) of the cyclone (3).

39. A method according to claim 10, wherein said carrier gas is an oxygen-containing, combustion promoting gas.

40. A method according to claim 10, wherein the combustion chamber (8) comprises a melt outlet opening (14) near or in a bottom of said combustion chamber (8).

41. A method according to claim 10, wherein at least one opening (17) for escape of exhaust gases from the combustion chamber (8) is tangentially connected to the combustion chamber (8) close to the discharge opening (9) of the cyclone (3).

42. A method according to claim 10, wherein the discharge opening (9) of the cyclone (3) is designed as a perforated downspout comprising openings (19) provided in a jacket of said discharge opening (9), and wherein said openings (19) run into a concentric ring channel arranged for at least one of supply of fuels and supply of a second carrier gas.

43. A method according to claim 10, wherein an exit nozzle for fuel into the combustion chamber (8) is designed as a slotted nozzle.

44. A method according to claim 43, wherein slot width of the slotted nozzle is adjustable.
